(19) United States
(12) Patent Application Publication
(10) Pub. No.: US 2007/0152045 A1
(43) Pub. Date: Jul. 5, 2007

(54) Label for an electronic product that is electronically altered when the electronic product changes

(75) Inventors: Steven C. Erickson, Rochester, MN (US); Ivory Wellman Knipfer, Rochester, MN (US); Jeffrey George Komatsu, Kasson, MN (US); Fraser Allan Syme, Rochester, MN (US)

Correspondence Address: MARTIN & ASSOCIATES, LLC, P.O. BOX 548, CARTHAGE, MO, 64836-0548, US

(73) Assignee: INTERNATIONAL BUSINESS MACHINES CORPORATION, ARMONK, NY (US)

(21) Appl. No.: 11/321,600

(22) Filed: Dec. 29, 2005

(51) Int. Cl. G06Q 30/00; G06K 19/00

(52) U.S. Cl. 235/385; 235/487

(57) ABSTRACT

A label that can display information that is electronically written to the label is used instead of a traditional printed paper label on an electronic product. The label itself is made from any suitable material that can be electronically written that will maintain the last display state when power is removed from the label. The preferred embodiments include a memory that includes product information on the electronic product, along with a label interface that reads the product information from the memory and displays corresponding information on the label. The label interface monitors the product information in the memory, and anytime the product information changes, the label interface automatically writes the changed product information to the label. The result is a label for an electronic product that is automatically updated each time the electronic product changes to reflect the current state of the electronic product.

### BACKGROUND OF THE INVENTION

1. Technical Field

This invention generally relates to labeling, and more specifically relates to labeling of electronic products.

2. Background Art

Labeling is an important part of inventory control in any manufacturing environment. Adhesive paper labels have been used for decades to mark products. Some applications make the use of paper labels difficult and expensive. For example, some companies purchase generic electronic products from a manufacturer, then configure the generic part in different ways to generate several distinct parts. One example of this is shown in FIG. 1, where a single type of generic memory part is customized into three specific parts, with each specific part having its own part number once it is properly configured. The problem with paper labels is that the memory part is labeled by the manufacturer, and once the part is customized to a particular part number, it must be re-labeled. The process of re-labeling may include removing the old label, which is often difficult and can provide physical stress on the memory part. Even if a new label is simply placed over the old label, the labels for some devices, such as the memory parts in FIG. 1, are very small and difficult to place in the proper position. Without a way to reduce the cost and increase the efficiency of labeling, manufacturing companies will continue to face excessive cost in labeling and re-labeling products as the configuration of the product changes.

### DISCLOSURE OF INVENTION

According to the preferred embodiments, a label that can display information that is electronically written to the label is used instead of a traditional printed paper label on an electronic product. The label itself is made from any suitable material that can be electronically written that will maintain the last display state when power is removed from the label. There are many different types of digital paper and electronic paper known in the art that would be suitable for use as labels in the preferred embodiments. These are thin plastic films that allow the display of information in a non-volatile manner such that the display state remains when power is removed. The preferred embodiments include a memory that includes product information on the electronic product, along with a label interface that reads the product information from the memory and displays corresponding information on the label. The displayed information may include barcode information, and preferably includes human-readable information that identifies the electronic product. The label interface monitors the product information in the memory, and anytime the product information changes, the label interface automatically writes the changed product information to the label. The result is a label for an electronic product that is automatically updated each time the electronic product changes to reflect the current state of the electronic product.

The foregoing and other features and advantages of the invention will be apparent from the following more particular description of preferred embodiments of the invention, as illustrated in the accompanying drawings.

### DESCRIPTION OF DRAWINGS

The preferred embodiments of the present invention will hereinafter be described in conjunction with the appended drawings, where like designations denote like elements, and:

FIG. 1 is a diagram showing prior art customization of a generic part into three specific parts;

FIG. 2 is a flow diagram of a prior art method for a customer to receive and use an electronic part in a manufactured product;

FIG. 3 is prior art method for a service person to service a faulty part in a manufactured product;

FIG. 4 is a block diagram of an electronic product in accordance with the preferred embodiments;

FIG. 5 is a flow diagram of a method in accordance with the preferred embodiments for a label to automatically change as product information for an electronic product changes;

FIG. 6 is a flow diagram for dynamically updating a label on a product in the field in accordance with the preferred embodiments;

FIG. 7 is a flow diagram of a method in accordance with the preferred embodiments for a customer to receive and use an electronic part in a manufactured product;

FIG. 8 is a top view of an electronic label on a memory module in accordance with the preferred embodiments;

FIG. 9 is a side view of the memory module in FIG. 8 taken along the line 9-9; and

FIG. 10 is a cross-sectional view of an electronic product that includes an enclosure 1030 with an electronic label 450 on the enclosure 1030 in accordance with the preferred embodiments.

### BEST MODE FOR CARRYING OUT THE INVENTION

1.0 Overview

The preferred embodiments relate to the labeling of electronic products. For those not familiar with current practices for labeling electronic products, this overview section will help to understand the present invention.

### Known Method for Labeling Electronic Products

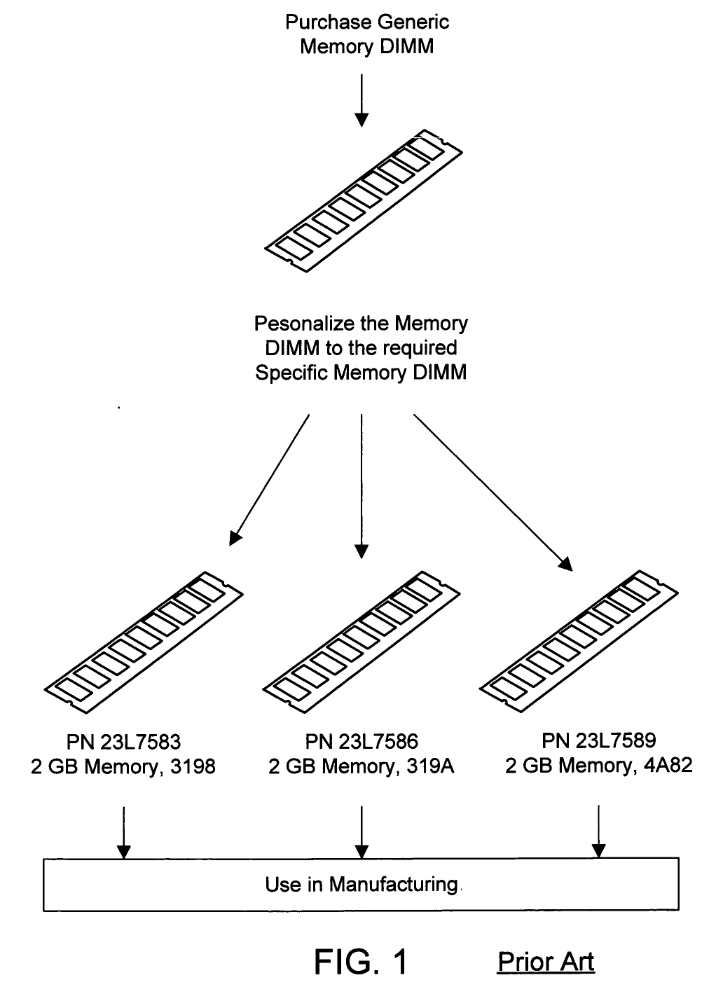

Ofttimes a manufacturer will purchase a generic electronic product, then modify the product in-house to generate multiple specific electronic products. An example of this is shown in FIG. 1. We assume a customer purchased a generic dual inline memory module (DIMM) from a supplier. This part is typically labeled with the supplier's part number. The customer may then electronically configure the generic part to be three different individual parts with corresponding individual part numbers, as shown in FIG. 1. Each of these three parts may then be used in manufacturing orders for customers.

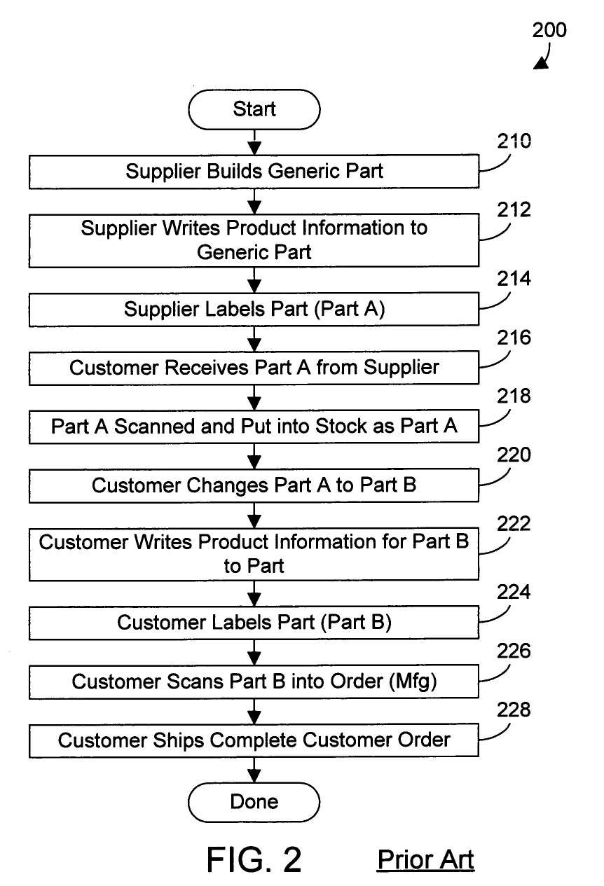

Method 200 in FIG. 2 shows the detailed steps that would be performed for the simple example in FIG. 1. First, the supplier builds the generic part (step 210). The supplier then writes product information to the generic part (step 212). Most electronic parts include a small memory chip that stores what is commonly referred to as vital product data (VPD). This vital product data is a description of the part. Once the VPD is written to the part, the supplier labels the part (step 214). For this specific example, we assume the supplier labels the generic part as Part A. The customer then receives Part A from the supplier (step 216). The label is scanned, and the part is put into stock as Part A (step 218). The customer then changes generic part A to a specific configuration we'll call Part B (step 220). The customer changes the vital product data to reflect the reconfiguration (step 222). The customer then labels the part as Part B (step 224). Once the part needs to be put into a manufacturing order, the customer scans the Part B into the order (step 226). The customer then ships the complete customer order (step 228), which includes Part B.

There are many problems associated with prior art method 200. Because the part is originally labeled as Part A, either the label for Part B must completely cover the label for Part A, or the label for Part A must be removed before applying the label for Part B. When dealing with small labels on small electronic products (such as a memory DIMM shown in FIG. 1), it is very difficult to align a new label in a precise location that completely covers an old label. Removing a label can prove to be very difficult, and can stress or damage the electronic product. In addition, the labeling process is typically a completely separate step from the process of customizing the part, so it add a step in the manufacturing process.

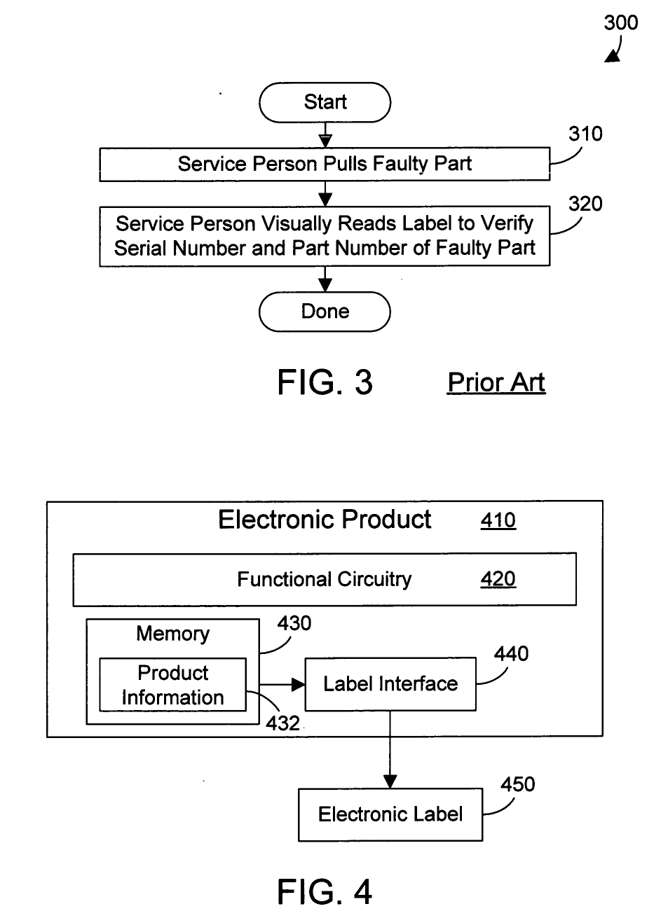

Another prior art method 300 is shown in FIG. 3. When a part in the field needs to be replaced, a service person typically pulls the faulty part (step 310), then visually reads the label to verity the serial number and part number of the faulty part (step 320). This visual verification is very important so the information on the label of the part being replaced can be visually compared to the information on the label of the replacement part, and so the service person can log the failure by serial number and part number.

2.0 Description of the Preferred Embodiments

The preferred embodiments recognize the inefficiency of using printed paper labels, and replace the printed paper labels with labels that may be written electronically. Any form of digital or electronic paper may be used for the label, whether currently known or developed in the future, as long as the display on the label is maintained when power is removed. An electronic product of the preferred embodiments includes a label interface that monitors for changes to the stored product information, and that re-writes the electronic label each time the stored product information changes. In this manner an electronic label is dynamically re-written each time the product information changes, eliminating the need to remove paper labels or align new paper labels over old paper labels. In addition, the electronic product may even be updated in the field, because the label interface will dynamically update the electronic label each time the product information changes, even if the change is done in the field.

Referring to FIG. 4, an electronic product 410 in accordance with the preferred embodiments includes functional circuitry 420 that defines the function of the electronic product. For example, functional circuitry 420 for a network interface card might include a network interface chipset. The electronic product 410 also includes a memory 430 that stores product information 432. Memory 430 is preferably non-volatile memory. Product information 432 may be any information relating to the electronic product 410. Vital product data (VPD) is known in the art as one suitable type of product information 432. A label interface 440 is coupled to the memory 430 and to an electronic label 450. The label interface 440 monitors the product information 432 in the memory 430, and each time the product information 432 changes, the label interface 440 writes information corresponding to the product information to the electronic label 450. In this manner, a change to the product information 432 is automatically reflected on the electronic label 450.

IBM uses the terminology “field replaceable unit” (FRU) to reflect any part that may be easily replaced in the field. Cards that reside in card slots on a motherboard are good examples of FRUs, but the term FRU applies to any and all field-replaceable items. Note that electronic product 410 in FIG. 4 includes IBM FRUs as well as any other suitable electronic product. The electronic label 450 of the preferred embodiments may be used on any type of electronic product, so long as memory 430 with product information 432 and label interface 440 exist within the electronic product 410, where the label interface 440 drives an electronic label 450 as shown in FIG. 4.

Electronic label 450 is any suitable media that can be electronically written, and that maintains the current state of the displayed information when power is removed. Examples of suitable media include electronic ink and electrochromic polymers. Electronic ink typically provides microcapsules that contain positively charged particles of one color and negatively charged particles of a different, contrasting color. The capsules are aligned using an electric field to display the desired color. Electrochromic polymers produces a color change in a persistent but reversible manner by means of an electrochemical reaction. Both electronic ink and electrochromic polymers have been used as “electronic paper.” In the preferred embodiments, the label interface 440 preferably provides power to the electronic label 450. This allows the label interface 440 to write to the label 450 anytime the label interface 440 is active and detects a change in the product information 432.

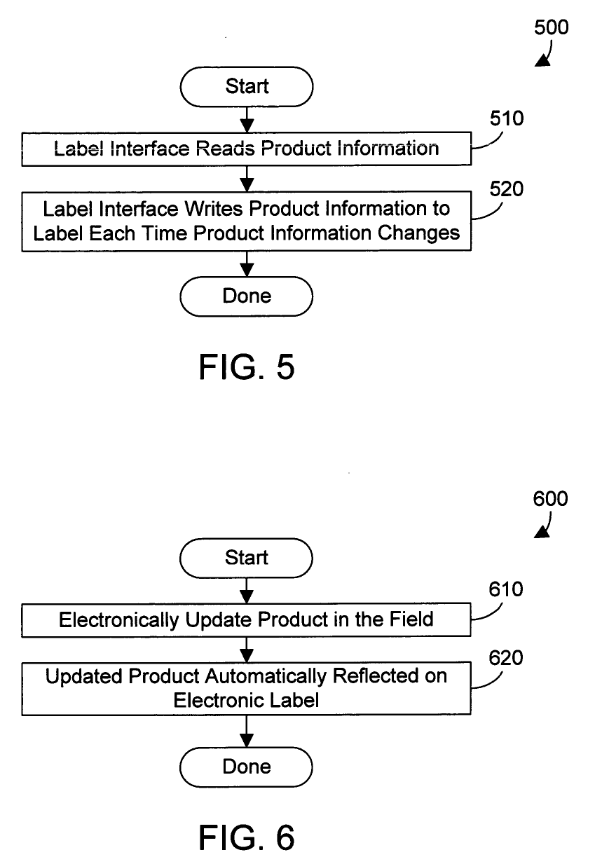

Referring to FIG. 5, a method 500 in accordance with the preferred embodiments shows how the label is dynamically changed as the product information is updated. The label interface reads the product information (step 510). The label interface writes the product information to the label each time the product information changes (step 520). Note that the product information read in step 510 may not be the exact information written in step 520. Known forms of digital and electronic paper may be written to electronically as a grid of display elements. The information written in step 520 certainly reflects the product information to the view of a human reader, but this product information read in step 510 will typically have to be converted to a bitmap to be displayed on the electronic label. As a result, the information written to the label may be the product information, or may be information in a graphical format that corresponds to the product information, depending on how the electronic label is formatted and the interface for writing to the electronic label. In addition, the label interface 440 may include a table that correlates product information to corresponding information to be displayed. Thus, the label interface 440 may read updated product information from the memory 430, find an entry in its internal table for the updated product information, and display corresponding information on the electronic label. The preferred embodiments expressly extend to the display of any suitable information on the label that correspond to the product information in some way.

The information that the label interface writes to the electronic label includes a human-readable form of information, and may optionally include a machine-readable form of information such as a barcode. Barcodes are still in widespread use for tracking parts and assemblies. The human-readable information on the electronic label 450 allows a human service person to visually read the serial number and part number of the electronic product. The machine-readable information on the electronic label 450 allows easy inventory tracking of the electronic product. Note that radio frequency identification (RFID) is becoming more and more popular, and will likely replace barcodes as the preferred way of tracking things. Even if RFID is used on an electronic assembly, there is still a need for a human-readable label so a quality assurance person can verify proper assembly and so a service person can determine the configuration of a failed part.

Referring to FIG. 6, method 600 in accordance with the preferred embodiments illustrates a huge advantage for the self-updating electronic labels described herein. Let's assume an electronic product is electronically updated in the field (step 610). The updated product is automatically reflected on the electronic label (step 620), assuming the update to the product produces an update to the stored product information. Because step 520 in FIG. 5 writes product information to the label each time the stored product information changes, a change in product information results in an automatic change in the label to reflect the change. This is a significant advantage when compared with the prior art. A simple example will illustrate.

A customer might purchase a generic processor from a manufacturer, then configure the generic processor to run at different speeds depending on microcode written to the processor. Let's assume a computer manufacturer buys generic processors that are capable of running at 3.0 GHz, then configures the processors into specific parts that run at 2.5 GHz, 2.8 GHz, and 3.0 GHz using microcode configuration discussed above. Now let's assume a customer purchases a computer system with a 2.5 GHz processor. The computer manufacturer could notify the customer at some point after the sale that the computer may be upgraded to a higher speed 3.0 GHz processor without a service call and without replacing the processor, for some fee. If the customer purchases the upgrade, an e-mail that contains an executable file could be sent to the user. When the user executes the executable file in the e-mail, the processor will be dynamically re-configured to run at 3.0 GHz by re-programming the processor with different microcode that produces the 3.0 GHz version of the part. As soon as the processor is re-programmed, its product information is updated, which causes the label interface on the processor to write the updated product information to the electronic label. In this manner, a change to an electronic product in the field causes a dynamic change in the electronic label to reflect that change. This assures that the label will always reflect the current state of the electronic product.

Note that automatic updating of a part as described above introduces complications and potential errors in prior art systems that use printed paper labels. While the processor could still be upgraded as described in the paragraph above from 2.5 GHz to 3.0 GHz, a paper label would not reflect the upgrade. Thus, the computer system would now have a processor running at 3.0 GHz while the label reflects a processor running at 2.5 GHz. Should the computer system need service due to the processor being faulty and the service person pulls the processor in step 310, the label on the processor will not match the actual configuration of the part. As a result, the service person might replace the 3.0 GHz processor with a 2.5 GHz processor, as indicated on the processor label. One alternative to solve this problem is for the service person to consult a database that indicates all in-field updates to the computer system since the computer system was shipped to the customer. Having the labels potentially out of sync with the actual configuration of the parts produces an additional level of complexity that may cause human errors when servicing the computer system.

The electronic label 450 of the preferred embodiments eliminates all the aforementioned problems because the information displayed on the label is automatically updated by the label interface anytime a change to the product information is detected. This allows for dynamically updating electronic products in the field with a knowledge that the information on the electronic label will always be correct. This, of course, greatly simplifies the job of a service person when servicing electronic products. In the simple example above, when the service person pulls the processor, the processor's electronic label will indicate a part number that reflects a 3.0 GHz processor. This allows the service person to replace the processor with a 3.0 GHz processor without consulting any database to determine or verify the current configuration of the processor. Thus, the electronic label of the preferred embodiments greatly simplifies service of the electronic product in the field.

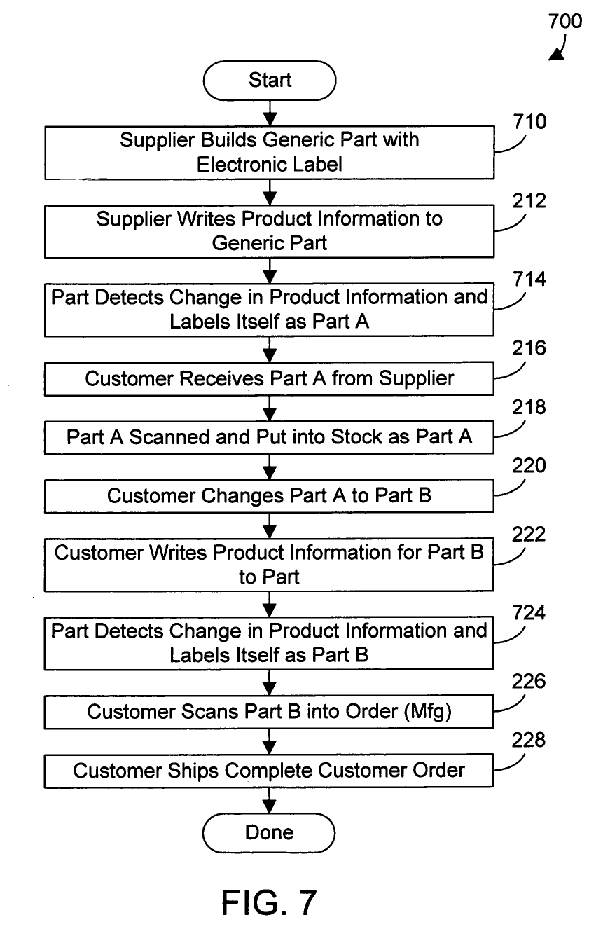

Referring to FIG. 7, we now examine method 700 in accordance with the preferred embodiments to compare and contrast the benefits of the preferred embodiments compared to prior art method 200 in FIG. 2. First, we assume the supplier builds a generic part with an electronic label (step 710). The supplier writes the product information to the generic part (step 212). The part itself detects the change in product information, and writes to the electronic label information corresponding to Part A to essentially label itself as Part A (step 714). The customer then receives the part from the supplier (step 216), and Part A is scanned and put into stock as Part A (step 218). The customer then customizes Part A to be Part B (step 220). The customer then writes the product information for Part B to the part (step 222). The part itself detects the change in product information, and writes to the electronic label information corresponding to Part B (step 724). The customer then scans Part B during manufacturing of an order (step 226). The customer then ships the complete customer order (step 228).

When comparing method 700 in FIG. 7 to prior art method 200 in FIG. 2, we see that the differences for this specific example are in steps 710, 714 and 724. Once the supplier puts the electronic label on the part in step 710, the part automatically labels itself with each change to the product information, as shown in step 714 and 724. By providing an electronic part that is self-labeling, the need to remove and replace labels is eliminated.

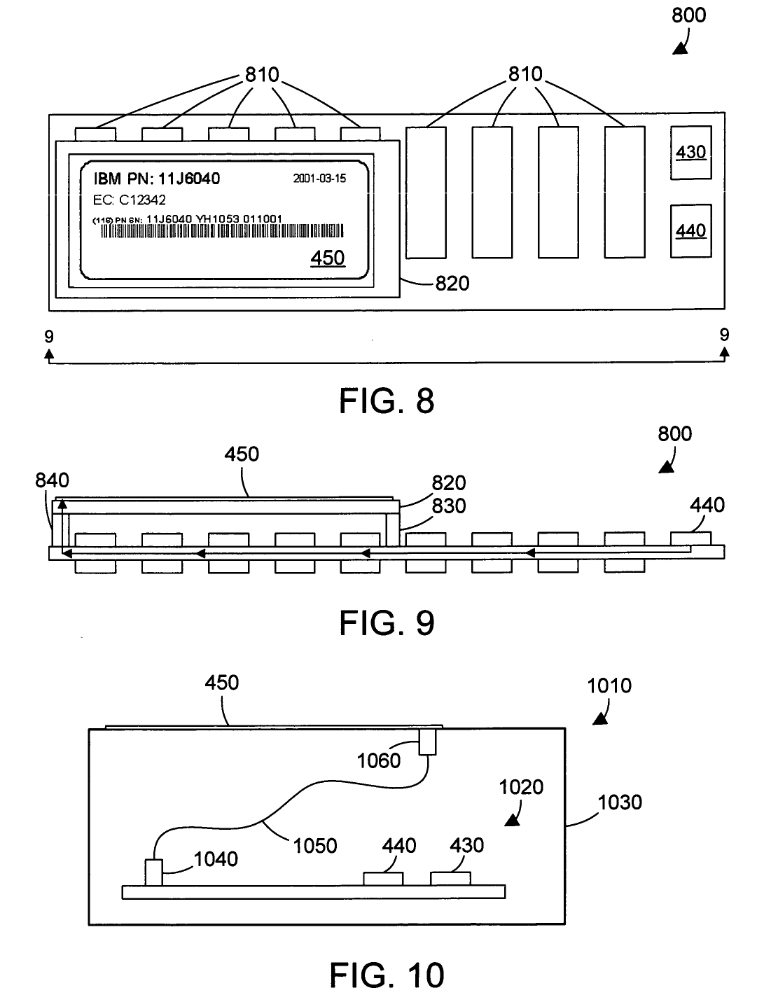

A simple example is now presented to illustrate the concepts of the preferred embodiments. Referring to FIG. 8, a memory DIMM 800 is one suitable example of the electronic product 410 in FIG. 4. The memory DIMM 800 includes memory chips 810, a memory 430 that holds the product information, and the label interface 440. The electronic label 450 is attached to a substrate 820, shown more clearly in FIG. 9, which provides structural support for the label 450. The electronic label 450 preferably displays a human-readable form of information, such as the IBM part number, 11J6040 shown in FIG. 8. The label 450 may optionally include a machine-readable form of information, such as the barcode shown in FIG. 8. Referring to FIG. 9, the substrate 820 is supported by support 830 and connector 840. Connector 840 provides electrical contact between the board on which the label interface 440 is mounted and the electronic label 450. Label interface 440 may thus drive the electronic label 450 via signal lines in the board, as shown by the line with arrows in FIG. 9. The result is a memory DIMM 800 that includes an electronic label 450 that is automatically updated anytime the product information in the memory DIMM 800 indicates a change to the part.

Note that some electronic products have physical enclosures, and the preferred embodiments herein extend to the placement of an electronic label on a physical enclosure, as shown in the cutaway view of FIG. 10. We assume an electronic product 1010 is an example of the electronic product 410 in FIG. 10. We further assume the electronic product 1010 includes an electronic assembly 1020 that includes the memory 430 that contains the product information (432 in FIG. 4) and the label interface 440, and that electronic assembly 1020 is housed in an enclosure 1030. The label interface 440 is electrically coupled to a connector 1040, which is connected via a suitable cable (such as a ribbon cable) to a connector 1060 that makes electrical contact with the electronic label 450 on the outside of the enclosure 1030. In this manner, the electronic product 1010 may be updated, and the update will be automatically reflected on the electronic label 450 on the outside of the enclosure 1030.

The term “product information” specifically includes vital product data (VPD) as is known in the art, but may include additional information as well. For example, the product information may include diagnostic or failure information. Thus, if a memory DIMM fails, its product information could be updated to reflect the failure, and the label could then be updated to display FAILED. A service person could then run a diagnostic that narrows the problem to a memory failure, then pull each DIMM and visually inspect for a failure indication on the label. Assuming a single DIMM failed, the service person could then replace only the failed DIMM without any need for further diagnostics to determine which DIMM had the failure by simply looking at the electronic label of each DIMM for the FAILED indication.

The average seek time for a hard disk drive could be displayed on the label, allowing a service person to visually determine whether the average seek time is within an expected range for that disk drive. Of course, other types of performance and diagnostic information could be displayed to aid a service person in servicing the electronic product. The preferred embodiments extend to the display of any and all suitable information for an electronic product on an electronic label.

The preferred embodiments provide an enhanced labeling system by providing an electronically writeable label that may be dynamically changed as the configuration of an electronic product is dynamically updated. This eliminates the need to remove labels or replace labels, and assures the information displayed on the label always reflects the current state of the electronic product.

One skilled in the art will appreciate that many variations are possible within the scope of the present invention. Thus, while the invention has been particularly shown and described with reference to preferred embodiments thereof, it will be understood by those skilled in the art that these and other changes in form and details may be made therein without departing from the spirit and scope of the invention.

What is claimed is:

1. An electronic product comprising:
a memory that contains product information for the electronic product;
a label that displays information electronically written to the label, and maintains a current display of information when power is removed from the label; and
a label interface coupled to the memory and coupled to the label that reads the product information from the memory and electronically writes data corresponding to the product information to the label.

2. The electronic product of claim 1 wherein the information displayed by the label includes a barcode representation of the electronic product.

3. The electronic product of claim 1 wherein the information displayed by the label includes a human-readable representation of the electronic product.

4. The electronic product of claim 1 wherein a change in the electronic product results in changing the product information in the memory, which results in the label interface automatically writing data corresponding to the changed product information to the label.

5. The electronic product of claim 1 wherein the electronic product provides power to the label and wherein the label interface writes the data to the label when the electronic product is powered.

6. The electronic product of claim 1 further comprising a connector that couples the label interface to the label.

7. The electronic product of claim 1 further comprising a cable that couples the label interface to the label.

8. The electronic product of claim 1 wherein the information written to the label comprises diagnostic information for the electronic product.

9. A method for labeling an electronic product comprising the steps of:
providing a memory on the electronic product that contains product information for the electronic product;
reading the product information from the memory; and
electronically writing data corresponding to the product information to a label for the electronic product, wherein the label displays information electronically written to the label and maintains a current display of information when power is removed from the label.

10. The method of claim 9 wherein the information displayed by the label includes a barcode representation of the electronic product.

11. The method of claim 9 wherein the information displayed by the label includes a human-readable representation of the electronic product.

12. The method of claim 9 wherein a change in the electronic product results in changing the product information in the memory, which results in the label interface electronically writing data corresponding to the changed product information to the label.

13. The method of claim 9 wherein the information written to the label comprises diagnostic information for the electronic product.

14. A method for updating a label on an electronic product, wherein the label displays information electronically written to the label and maintains a current display of information when power is removed from the label, the method comprising the steps of:
providing a memory on the electronic product that contains product information for the electronic product;
reading the product information from the memory;
electronically writing data corresponding to the product information to the label each time the product information changes; and
electronically updating the product information in the memory.

15. A method for updating an electronic product, the method comprising the steps of:
providing a memory on the electronic product that contains product information for the electronic product;
reading the product information from the memory;
electronically writing data corresponding to the product information to a label for the electronic product, wherein the label displays information electronically written to the label and maintains a current display of information when power is removed from the label;
electronically updating the electronic product;
electronically updating the product information in the memory to reflect the updating of the electronic product; and
electronically writing data corresponding to the updated product information to the label.

16. The method of claim 15 wherein the information displayed by the label includes a barcode representation of the electronic product.

17. The method of claim 15 wherein the information displayed by the label includes a human-readable representation of the electronic product.

18. The method of claim 15 wherein the electronic product provides power to the label and wherein the data is written to the label when the electronic product is powered.

19. The method of claim 15 wherein the information written to the label comprises diagnostic information for the electronic product.
